(19) United States
(12) Patent Application Publication
(10) Pub. No.: US 2022/0376999 A1
(43) Pub. Date: Nov. 24, 2022

(54) INFORMATION PROCESSING DEVICE, INFORMATION PROCESSING METHOD, AND NON-TRANSITORY COMPUTER READABLE STORAGE MEDIUM

(71) Applicant: Yahoo Japan Corporation, Tokyo (JP)

(72) Inventors: Hidehito GOMI, Tokyo (JP); Kota TSUBOUCHI, Tokyo (JP); Teruhiko TERAOKA, Tokyo (JP)

(21) Appl. No.: 17/686,982

(22) Filed: Mar. 4, 2022

(30) Foreign Application Priority Data
Mar. 18, 2021 (JP) 2021-045242

(51) Int. Cl. H04L 43/0805; H04L 43/16; H04L 41/16

(52) U.S. Cl. CPC H04L 43/0805; H04L 43/16; H04L 41/16

(57) ABSTRACT

An information processing device according to the present application includes a determiner and an acquisitor. In a case where the information processing device is a first device that acquires context data held by a second device, the determiner determines reliability of the second device with respect to the first device on the basis of reliability of the second device with reference to a third device that is reliable with respect to the first device. The acquisitor acquires context data from the second device in a case where the determiner determines that the second device is reliable.

### CROSS-REFERENCE TO RELATED APPLICATION

The present application claims priority to and incorporates by reference the entire contents of Japanese Patent Application No. 2021-045242 filed in Japan on Mar. 18, 2021.

### BACKGROUND OF THE INVENTION

### 1. Field of the Invention

The present invention relates to an information processing device, an information processing method, and a non-transitory computer readable storage medium.

### 2. Description of the Related Art

A technology to provide a context-aware platform for realizing a ubiquitous society has been conventionally proposed (see, for example, JP 2017-503371 A). Such a technology is for sharing various context data acquired by various sensor devices unevenly distributed in a real space including a computer.

However, the above prior art has room for further improvement in sharing reliable context data.

### SUMMARY OF THE INVENTION

According to one aspect of the subject described in the present disclosure, an information processing device includes a determiner and an acquisitor. In a case where the information processing device is a first device that acquires context data held by a second device, the determiner determines reliability of the second device with respect to the first device on the basis of reliability of the second device with reference to a third device that is reliable with respect to the first device. The acquisitor acquires context data from the second device in a case where the determiner determines that the second device is reliable.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating an example of information processing according to an embodiment;

FIG. 2 is a view illustrating a configuration example of an information processing system according to the embodiment;

FIG. 3 is a block diagram illustrating a configuration example of a terminal device according to the embodiment;

FIG. 4 is a view illustrating an example of reliability information;

FIG. 5 is an explanatory diagram of a determination model;

FIG. 6 is an explanatory diagram (part 1) of a determination threshold;

FIG. 7 is an explanatory diagram (part 2) of a determination threshold;

FIG. 8 is a processing sequence executed by the information processing system according to the embodiment; and

FIG. 9 is a hardware configuration diagram illustrating an example of a computer that implements functions of the terminal device according to the embodiment.

### DETAILED DESCRIPTION OF THE PREFERRED EMBODIMENT

A mode (hereinafter referred to as “embodiment”) for carrying out an information processing device, an information processing method, and an information processing program according to the present application will be described below in detail with reference to the drawings. Note that the information processing device, the information processing method, and the information processing program according to the present application are not limited by this embodiment. Each embodiment can be appropriately combined within a range in which processing contents do not contradict each other. In each of the following embodiments, the same parts are denoted by the same reference numerals, and redundant description will be omitted.

### 1. Example of Information Processing

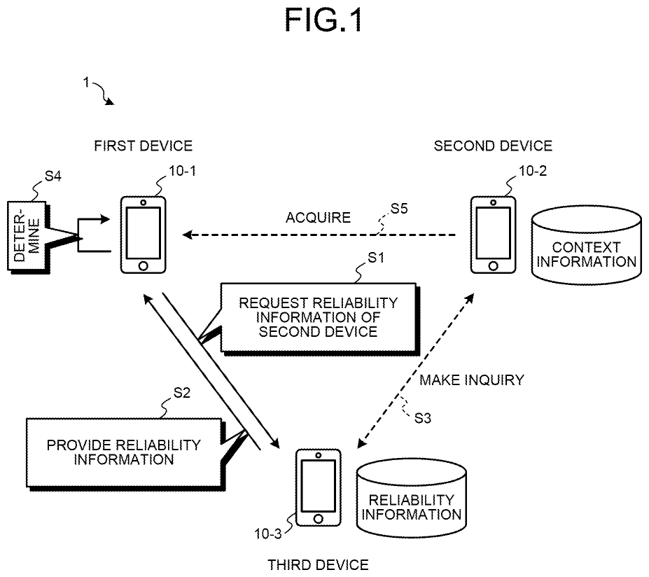

First, an example of information processing according to an embodiment will be described with reference to FIG. 1. FIG. 1 is a view illustrating an example of information processing according to the embodiment.

FIG. 1 illustrates an example in which in a case where a terminal device 10-1, which is an example of an information processing device included in an information processing system 1 according to the embodiment, is a first device that acquires context data held by a second device, the terminal device 10-1 executes processing of determining reliability of the second device with respect to the first device on the basis of reliability of the second device with reference to a third device that is reliable with respect to the first device, and acquiring the context data from the second device in a case where the second device is determined to be reliable.

As illustrated in FIG. 1, the information processing system 1 according to the embodiment includes terminal devices 10-1, 10-2, and 10-3. As illustrated in FIG. 1, the terminal device 10-1 corresponds to an example of the first device. Furthermore, the terminal device 10-2 corresponds to an example of the second device. Furthermore, the terminal device 10-3 corresponds to an example of the third device.

The terminal devices 10-1, 10-2, and 10-3 are provided to enable peer-to-peer wireless communication, and can form an ad-hoc network that is a context environment. Note that the terminal devices 10-1, 10-2, and 10-3 will be described as appropriate below as “terminal device 10” in a case where it is not particularly necessary to distinguish them.

The terminal device 10 is an example of a sensor device including various sensors. For example, the terminal device 10 is a terminal device that includes a G sensor, a gyro sensor, and a global positioning system (GPS) sensor, and is used by the user for various types of information processing via a human machine interface (HMI).

In such a case, the terminal device 10 is, for example, an information processing device such as a mobile phone including a smartphone, a tablet terminal, a desktop PC, a laptop PC, or a personal digital assistant (PDA). Furthermore, the terminal device 10 also includes a wearable device, which is an eyeglass-type or watch-type information processing device. In addition, computing machinery such as a server or a workstation is also included. Furthermore, the terminal device 10 may be a video game console or the like capable of so-called StreetPass Communication (registered trademark).

Furthermore, for example, the terminal device 10 is various sensor devices that respectively specifically sense video, audio, temperature, humidity, atmospheric pressure, biological information, and the like.

Here, a case where it is desired that the terminal device 10-1, which is the first device, acquires context data held by the terminal device 10-2 as context information from the terminal device 10-2, which is the second device, will be considered. Therefore, the terminal device 10-3, which is the third device, is positioned as one or more third-party devices other than the first device and the second device.

Then, it is assumed to be desired that the terminal device 10-1 acquires context data from the terminal device 10-2, but it is unknown whether the terminal device 10-2 is a partner to share reliable context data.

In such a case, in the information processing method according to the embodiment, in a case where a first device acquires context data held by a second device, the first device determines reliability of the second device with respect to the first device on the basis of reliability of the second device with reference to a third device that is reliable with respect to the first device, and acquires the context data from the second device in a case where the second device is determined to be reliable.

Specifically, as illustrated in FIG. 1, in the information processing method according to the embodiment, the terminal device 10-1 first requests the terminal device 10-3 for reliability information regarding the reliability of the terminal device 10-2 (step S1).

At this time, it is assumed that the terminal device 10-3 is a partner to share context data already reliable for the terminal device 10-1. Then, if the terminal device 10-3 itself holds the reliability information of the terminal device 10-2, the terminal device 10-3 provides the terminal device 10-1 with the reliability information (step S2).

In addition, if the terminal device 10-3 itself does not hold the reliability information of the terminal device 10-2, the terminal device 10-3 may make an inquiry to the terminal device 10-2 about the reliability (step S3) and generate the reliability information of the terminal device 10-2 from the communication history or the like.

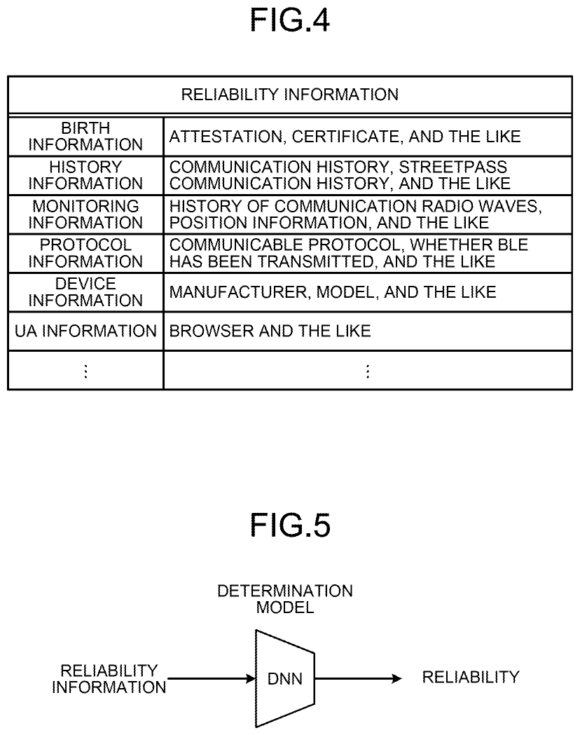

Furthermore, the terminal device 10-3 may periodically monitor the terminal device 10-2 and cache the reliability information of the terminal device 10-2. Note that specific content of the reliability information will be described later with reference to FIG. 4. In addition, the terminal device 10-3 may generate the reliability information of the second device by making an inquiry to a fourth device that can be determined to hold the reliability information of the second device.

Then, the terminal device 10-1 provided with the reliability information of the terminal device 10-2 determines the reliability of the terminal device 10-2 on the basis of the reliability information (step S4). The terminal device 10-1 can use a determination model learned using, for example, an algorithm of machine learning for such determination processing. This point will be described later with reference to FIG. 5.

Then, if being able to determine in step S4 that the terminal device 10-2 is a partner to share reliable context data, the terminal device 10-1 acquires context data held by the terminal device 10-2 from the terminal device 10-2 (step S5).

By going through such a series of procedures, the information processing system 1 becomes possible to form a reliable ad-hoc network by the reliable terminal devices 10, for example.

As described above, in the information processing method according to the embodiment, in a case where a first device acquires context data held by a second device, the first device determines reliability of the second device with respect to the first device on the basis of reliability of the second device with reference to a third device that is reliable with respect to the first device, and acquires the context data from the second device in a case where the second device is determined to be reliable.

Therefore, according to the information processing method according to the embodiment, it is possible to share reliable context data.

Hereinafter, the information processing system 1 including an information processing device that performs information processing as described above will be described in detail.

### 2. Configuration of Information Processing System 1

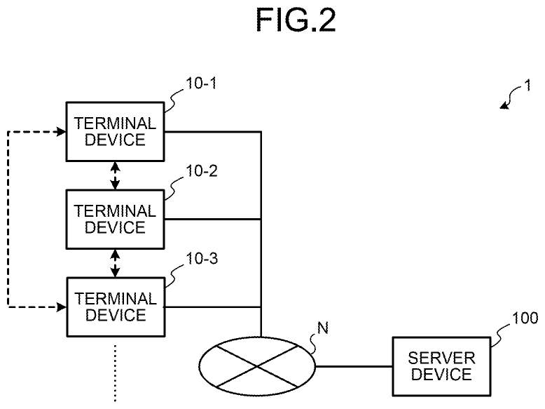

FIG. 2 is a view illustrating the configuration example of the information processing system 1 according to the embodiment. As illustrated in FIG. 2, the information processing system 1 according to the embodiment includes the plurality of terminal devices 10-1, 10-2, 10-3, . . . , and a server device 100.

These various devices are communicably connected in a wired or wireless manner via a network N. The network N is a communication network such as a local area network (LAN), a wide area network (WAN), a telephone network (mobile telephone network, landline network, or the like), a regional Internet protocol (IP) network, or the Internet. The network N may include a wired network or may include a wireless network.

Furthermore, as described above, the terminal devices 10-1, 10-2, 10-3, . . . are provided to enable peer-to-peer wireless communication as indicated by a broken arrow in FIG. 2. Since the terminal device 10 has been described, detailed description thereof is omitted here.

The server device 100 is an information processing device that provides various services to a user. The service provided by the server device 100 is, for example, a service of providing various types of information via various applications or browsers installed in the terminal device 10. In addition to a search service, the services to be provided may include, for example, a news providing service, an auction service, a weather forecast service, a shopping service, a financial transaction (stock transaction or the like) service, a route search service, a map providing service, a travel service, a restaurant introduction service, and blog service.

Furthermore, the server device 100 can identify and authenticate the terminal device 10 and provide various services according to an ad-hoc network in which the corresponding terminal device 10 exists, that is, a context environment.

### 3. Terminal Device 10

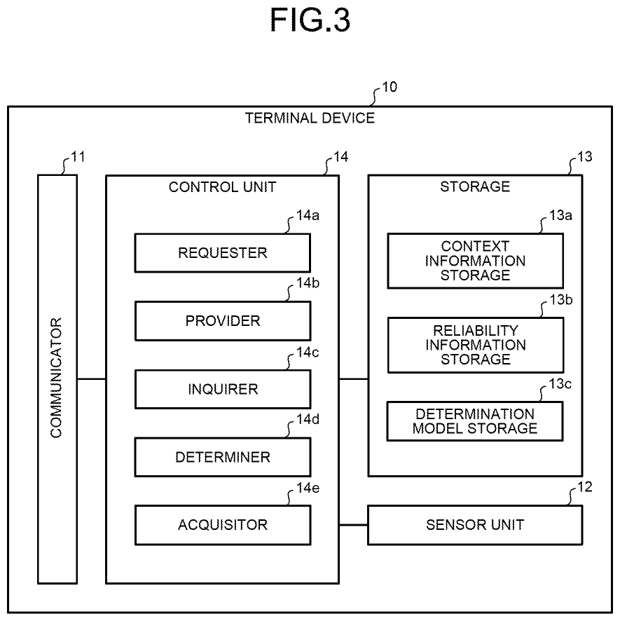

Next, a configuration example of the terminal device 10 will be described with reference to FIG. 3. FIG. 3 is a block diagram illustrating a configuration example of the terminal device 10 according to the embodiment. Note that FIG. 3 illustrates only components necessary for description of the terminal device 10, and description of general components is omitted.

As illustrated in FIG. 3, the terminal device 10 includes a communicator 11, a sensor unit 12, a storage 13, and a control unit 14. Note that the terminal device 10 may include an inputter (e.g., a keyboard, a mouse, or the like) that receives various operations from a user or the like who uses the terminal device 10, a display unit (e.g., a liquid crystal display or the like) for displaying display information, and a speaker for outputting audio information.

### Communicator 11

The communicator 11 is implemented by, for example, a network interface card (NIC) or the like. The communicator 11 is connected to the network N in a wired or wireless manner, and transmits and receives information to and from the server device 100 via the network N.

Furthermore, the communicator 11 is connected to another terminal device 10 to be able to perform wireless communication in a peer-to-peer manner, and transmits and receives information to and from another terminal device 10. Note that Wi-Fi (registered trademark), Bluetooth (registered trademark), ultra wide band (UWB), near field communication (NFC), or the like can be used as the wireless communication method.

### Sensor Unit 12

The sensor unit 12 is mounted on the terminal device 10 and includes one or more sensors that acquire sensing data indicating various contexts in a space where the terminal device 10 exists.

### Storage 13

The storage 13 is implemented by, for example, a semiconductor memory element such as a random access memory (RAM) or a flash memory, or a storage device such as a hard disk or an optical disk, and in the example of FIG. 3, the storage 13 includes a context information storage 13a, a reliability information storage 13b, and a determination model storage 13c.

### Context Information Storage 13a

The context information storage 13a stores context data from the sensor unit 12 acquired by an acquisitor 14e described later and context data from another terminal device 10.

### Reliability Information Storage 13b

The reliability information storage 13b stores reliability information regarding another terminal device 10. Here, an example of reliability information will be described. FIG. 4 is a view illustrating an example of reliability information. As illustrated in FIG. 4, for example, the reliability information includes birth information, history information, monitoring information, protocol information, device information, and user agent (UA) information. Furthermore, sensor information necessary for acquiring the context information, and an acquisition method thereof may be included.

As illustrated in FIG. 4, the birth information includes information regarding an attestation and a certificate of another terminal device 10. Furthermore, the history information includes a communication history and a street-pass history by StreetPass Communication.

In addition, the monitoring information includes a history of communication radio waves and position information. In addition, the protocol information includes a communicable protocol and whether Bluetooth Low Energy (BLE) has been transmitted.

Furthermore, the device information includes a manufacturer and a model of another terminal device 10. Furthermore, the UA information includes a browser.

### Determination Model Storage 13c

The description returns to FIG. 3. The determination model storage 13c stores a determination model used for determination processing executed by a determiner 14d described later. Here, the determination model will be described. FIG. 5 is an explanatory diagram of the determination model.

As illustrated in FIG. 5, the determination model is a deep neural network (DNN) learned in advance using an algorithm of machine learning so as to calculate the reliability of the other terminal device 10 corresponding to the reliability information on the basis of the reliability information as illustrated in FIG. 4, for example.

The determiner 14d described later calculates the reliability of the other terminal device 10 by inputting the acquired reliability information of the other terminal device 10 to the determination model.

### Control Unit 14

The description returns to FIG. 3. The control unit 14 is a controller, and is implemented by, for example, a central processing unit (CPU), a micro processing unit (MPU), or the like executing various programs (corresponding to an example of an information processing program) stored in a storage device inside the terminal device 10 with a RAM as a work area. Furthermore, the control unit 14 is, for example, a controller, and is implemented by an integrated circuit such as an application specific integrated circuit (ASIC) or a field programmable gate array (FPGA).

As illustrated in FIG. 3, the control unit 14 includes a requester 14a, a provider 14b, an inquirer 14c, the determiner 14d, and the acquisitor 14e, and implements or executes the functions and actions of the information processing described below. Note that the internal configuration of the control unit 14 is not limited to the configuration illustrated in FIG. 3, and may be another configuration as long as the information processing described later can be performed. Furthermore, the connection relationship of the processors included in the control unit 14 is not limited to the connection relationship illustrated in FIG. 3, and may be another connection relationship.

In a case where the terminal device 10 is a first device that acquires context data held by a second device, the control unit 14 determines reliability of the second device with respect to the first device on the basis of reliability of the second device with reference to a third device that is reliable with respect to the first device, and acquires the context data from the second device in a case where the second device is determined to be reliable.

### Requester 14a

In a case where the terminal device 10 is the first device described above, when acquiring context data held by the terminal device 10 that is the second device, the requester 14a requests the terminal device 10 that is the third device for reliability information of the second device via the communicator 11.

### Provider 14b

In a case where the terminal device 10 is the third device and reliability information of the second device is requested from the terminal device 10 that is the first device, if holding corresponding reliability information, the provider 14b provides the corresponding reliability information to the first device via the communicator 11.

### Inquirer 14c

In a case where the terminal device 10 is the third device and reliability information of the second device is requested from the terminal device 10 that is the first device, if not holding corresponding reliability information, the inquirer 14c makes an inquiry to the second device via the communicator 11.

Furthermore, in a case where the reliability information of the second device can be generated from the communication history or the like as a result of an inquiry, the inquirer 14c causes the provider 14b to provide the first device with the generated reliability information via the communicator 11. Note that the inquirer 14c may periodically monitor the second device via the communicator 11 and always cache the latest reliability information of the second device.

### Determiner 14d

In a case where the acquisitor 14e described later has acquired the reliability information of the second device requested to the third device, the determiner 14d calculates the reliability of the second device using the determination model stored in the determination model storage 13c. Furthermore, in a case where the calculated reliability exceeds a predetermined determination threshold, the determiner 14d determines that the second device is reliable and causes the acquisitor 14e to acquire context data from the second device.

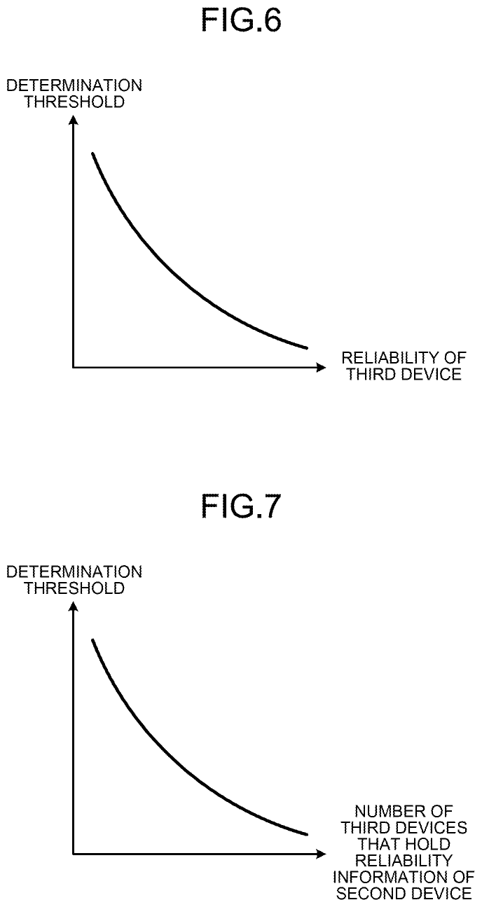

Here, the determination threshold in the determination processing executed by the determiner 14d will be described. FIG. 6 is an explanatory diagram (part 1) of the determination threshold. FIG. 7 is an explanatory diagram (part 2) of the determination threshold.

In the first place, in the information processing method according to the embodiment, the reliability of the third device needs to be ensured. Therefore, the terminal device 10 that is the first device calculates the reliability of the third device from the reliability information of the third device based on the past communication history and the like, and stores the reliability in the reliability information storage 13b.

Then, as illustrated in FIG. 6, the determiner 14d performs determination processing of determining the reliability of the second device by using a determination threshold that decreases as the reliability of the third device increases, for example. This makes it possible to appropriately determine the reliability of the second device in consideration of the reliability of the third device.

In addition, as illustrated in FIG. 7, the determiner 14d may determine the reliability of the second device by using a determination threshold that decreases as the number of third devices holding the reliability information of the second device increases, for example. This makes it possible to appropriately determine the reliability of the second device according to the number of third devices holding the reliability information of the second device, that is, the number of third devices that rely the second device.

### Acquisitor 14e

The description returns to FIG. 3. The acquisitor 14e acquires the context data acquired by the sensor unit 12 and causes the context information storage 13a to store the context data. Furthermore, the acquisitor 14e acquires the context data from another terminal device 10 via the communicator 11, and causes the context information storage 13a to store the context data.

Furthermore, in a case where the determiner 14d determines that the second device is reliable, the acquisitor 14e acquires the context data held by the second device from the second device via the communicator 11, and causes the context information storage 13a to store the context data.

### 4. Processing Sequence of Information Processing System 1

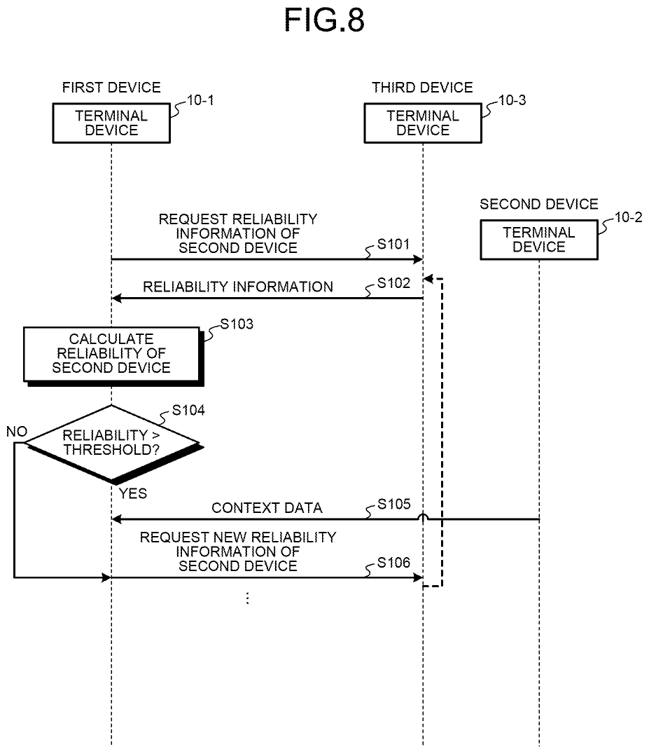

Next, the processing sequence executed by the information processing system 1 according to the embodiment will be described. FIG. 8 is a processing sequence executed by the information processing system 1 according to the embodiment. Note that in the description with reference to FIG. 8, as described above, it is assumed that the terminal device 10-1 is the first device, the terminal device 10-2 is the second device, and the terminal device 10-3 is the third device.

As illustrated in FIG. 8, first, the terminal device 10-1 requests the terminal device 10-3 for reliability information of the second device (step S101). The terminal device 10-3 that has received this provides the terminal device 10-1 with the reliability information of the second device (step S102).

Note that although illustration is omitted, if not holding the reliability information of the second device, the terminal device 10-3 can also make an inquiry to the terminal device 10-2, which is the second device, and generate reliability information from the communication history or the like.

Then, the terminal device 10-1 provided with the reliability information of the second device calculates the reliability of the second device on the basis of the reliability information (step S103). Then, the terminal device 10-1 determines whether the calculated reliability exceeds a predetermined determination threshold (step S104).

Here, if the reliability exceeds the determination threshold (Yes in step S104), the terminal device 10-1 acquires context data from the terminal device 10-2, which is the second device (step S105). In addition, if the reliability does not exceed the determination threshold (No in step S104), the terminal device 10-1 requests (step S106) the terminal device 10-3, for example, for the reliability information of new second device, and repeats the processing sequence from step S102.

### 5. Hardware Configuration

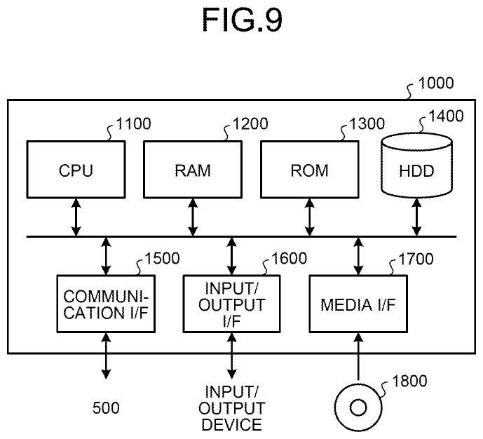

The terminal device 10 and the server device 100 according to the above-described embodiment are implemented by a computer 1000 having a configuration as illustrated in FIG. 9, for example. Hereinafter, the terminal device 10 will be described as an example. FIG. 9 is a hardware configuration diagram illustrating an example of the computer that implements functions of the terminal device according to the embodiment. The computer 1000 includes a central processing unit (CPU) 1100, a random access memory (RAM) 1200, a read only memory (ROM) 1300, a hard disk drive (HDD) 1400, a communication interface (I/F) 1500, an input/output interface (I/F) 1600, and a media interface (I/F) 1700.

The CPU 1100 operates on the basis of a program stored in the ROM 1300 or the HDD 1400, and controls each unit. The ROM 1300 stores a boot program executed by the CPU 1100 when the computer 1000 is started, a program dependent on hardware of the computer 1000, and the like.

The HDD 1400 stores a program executed by the CPU 1100, data used by the program, and the like. The communication interface 1500 receives and transmits, to the CPU 1100, data from other equipment via a communication network 500 (corresponding to the network N illustrated in FIG. 2 or peer-to-peer communication), and transmits the data generated by the CPU 1100 to other equipment via the communication network 500.

The CPU 1100 controls an output device such as a display and a printer and an input device such as a keyboard and a mouse via the input/output interface 1600. The CPU 1100 acquires data from the input device via the input/output interface 1600. In addition, the CPU 1100 outputs generated data to the output device via the input/output interface 1600.

The media interface 1700 reads a program or data stored in a recording medium 1800 and provides the program or data to the CPU 1100 via the RAM 1200. The CPU 1100 loads the program from the recording medium 1800 onto the RAM 1200 via the media interface 1700, and executes the loaded program. The recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the terminal device 10 according to the embodiment, the CPU 1100 of the computer 1000 implements each function of the control unit 14 by executing the program loaded onto the RAM 1200. In addition, the HDD 1400 stores data in the storage 13. The CPU 1100 of the computer 1000 reads, from the recording medium 1800, and executes these programs, but as another example, the CPU 1100 may acquire these programs from another device via the communication network 500.

### 6. Others

Furthermore, among the processing described in the above embodiment, all or a part of the processing described as being automatically performed can be manually performed, or all or a part of the processing described as being manually performed can be automatically performed by a known method. In addition to this, the processing procedures, specific names, and information including various data and parameters that are presented in the document and drawings can be discretionarily changed unless otherwise specified. For example, the various types of information illustrated in the drawings are not limited to the information illustrated.

Each component of each device illustrated is functionally conceptual, and is not necessarily configured physically as illustrated in the drawings. That is, a specific form of distribution and integration of each device is not limited to that illustrated, and all or a part thereof can be configured in such a manner being functionally or physically distributed and integrated in discretionary units according to various loads, usage conditions, and the like.

For example, the requester 14a and the provider 14b illustrated in FIG. 3 may be integrated in the sense that they are via the same communicator 11. Furthermore, the inquirer 14c may be integrated in the sense that it is also via the communicator 11. Furthermore, the acquisitor 14e may be integrated in the sense that it is also via the communicator 11. Furthermore, for example, information stored in the storage 13 may be stored in a predetermined storage device provided outside via the network N.

In addition, the “reliability of the device” referred to in the above embodiment is a concept including the reliability of the entire device, the reliability of each of one or more sensors included in the device, and the reliability of each piece of context data acquired by the device from the sensor.

Therefore, the determiner 14d may be provided to be able to determine the reliability of the second device for the entire device, for each sensor, or for each piece of context data, and the acquisitor 14e may be provided to be able to acquire context data from the second device for the entire device, for each sensor, or for each piece of context data determined to be reliable by the determiner 14d. This makes it possible to designate the acquisition source of context data in more detail and possible to ensure the quality of data to be acquired.

Furthermore, in the above embodiment, an example has been described in which context data is basically acquired directly from the second device when the second device is determined to be reliable, but the present invention is not limited to this, and context data may be acquired from the second device via the third device. In such a case, since the first device can acquire context data only by exchanging with a partner that is reliable for the first device, it is possible to ensure safety.

Furthermore, in the above embodiment, an example has been described in which the number of the third devices is basically one, but there may be a plurality of third devices. Then, in such a case, the first device may make an inquiry to the plurality of third devices about the reliability of the second device, and determine the reliability of the second device by majority decision, for example. This makes it possible to determine the reliability without bias.

In addition, the above-described embodiment and modification can be appropriately combined within a range in which processing contents do not contradict each other.

### 7. Effects

The terminal device 10 (corresponding to an example of “information processing device”) according to the embodiment includes the determiner 14d and the acquisitor 14e. In a case where the terminal device 10 is a first device that acquires context data held by a second device, the determiner 14d determines reliability of the second device with respect to the first device on the basis of reliability of the second device with reference to a third device that is reliable with respect to the first device. The acquisitor 14e acquires context data from the second device in a case where the determiner 14d determines that the second device is reliable.

Therefore, the terminal device 10 according to the embodiment can share reliable context data.

Furthermore, the terminal device 10 according to the embodiment further includes the requester 14a that requests, in a case where the terminal device 10 is the first device, reliability information that is information regarding reliability of the second device to the third device before acquiring the context data. The determiner 14d determines the reliability of the second device on the basis of the reliability information provided from the third device in response to the request by the requester 14a.

Therefore, on the basis of the reliability information provided by the third device, the terminal device 10 according to the embodiment makes it possible to determine the reliability of the second device, and possible to share reliable context data.

Furthermore, the reliability information includes at least any of birth information, history information, monitoring information, protocol information, device information, and UA information of the second device, and the determiner 14d calculates the reliability of the second device using a determination model learned so as to calculate the reliability of the second device on the basis of the reliability information, and determines that the second device is reliable when the calculated reliability exceeds a predetermined determination threshold.

Therefore, the terminal device 10 according to the embodiment makes it possible to determine the reliability of the second device by using a determination model such as a DNN learned using an algorithm of machine learning, and possible to share reliable context data.

In addition, the determiner 14d determines the reliability of the second device by using a determination threshold that changes according to the reliability of the third device.

Therefore, the terminal device 10 according to the embodiment makes it possible to appropriately determine the reliability of the second device in consideration of the reliability of the third device.

Furthermore, the terminal device 10 according to the embodiment further includes the inquirer 14c that, in a case where the terminal device 10 is the third device, makes an inquiry to the second device about reliability of the second device upon receiving a request for the reliability information from the first device.

Therefore, according to the terminal device 10 according to the embodiment, if the third device does not hold the reliability information of the second device, according to this, the third device can perform direct communication with the second device to generate reliability information.

In addition, the acquisitor 14e acquires context data from the second device via the third device when the determiner 14d determines that the second device is reliable.

Therefore, according to the terminal device 10 according to the embodiment, since the first device can acquire context data only by exchanging with a partner that is reliable for the first device, it is possible to ensure safety.

Furthermore, the reliability of the device includes the reliability of the entire device, the reliability of each of one or more sensors included in the device, and the reliability of each piece of context data acquired by the device from the sensor, the determiner 14d can determine the reliability of the second device for the entire device, for each sensor, or for each piece of context data, and the acquisitor 14e can acquire context data from the second device for the entire device, for each sensor, or for each piece of context data determined to be reliable by the determiner 14d.

Therefore, according to the terminal device 10 according to the embodiment, since the first device can acquire context data only by exchanging with a partner that is reliable for the first device, it is possible to ensure safety. It becomes possible to designate the acquisition source of context data in more detail and possible to ensure the quality of data to be acquired.

While the embodiment of the present application has been described in detail with reference to the drawings, this is merely an example, and the present invention can be carried out in other forms to which various modifications and improvements have been made on the basis of the knowledge of those skilled in the art including the aspects described in the disclosure of the invention.

In addition, the “unit” and the suffixes “-or” and “-er” described above can be read as “means”, “circuit”, or the like. For example, the acquisitor can be read as an acquisition means or an acquisition circuit.

According to an aspect of the embodiment, there is an effect that reliable context data can be shared.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a determiner that, in a case where the information processing device is a first device that acquires context data held by a second device, determines reliability of the second device with respect to the first device based on reliability of the second device with reference to a third device that is reliable with respect to the first device; and
an acquisitor that acquires the context data from the second device in a case where the determiner determines that the second device is reliable.

2. The information processing device according to claim 1 further comprising:
a requester that requests, in a case where the information processing device is the first device, reliability information that is information regarding reliability of the second device to the third device before acquiring the context data, wherein
the determiner
determines reliability of the second device based on the reliability information provided by the third device in response to a request by the requester.

3. The information processing device according to claim 2, wherein
the reliability information includes
at least any of birth information, history information, monitoring information, protocol information, device information, and user agent (UA) information of the second device, and
the determiner
calculates reliability of the second device by using a determination model learned to calculate reliability of the second device based on the reliability information, and determines that the second device is reliable when calculated reliability exceeds a predetermined determination threshold.

4. The information processing device according to claim 3, wherein
the determiner
determines reliability of the second device by using the determination threshold that changes according to reliability of the third device.

5. The information processing device according to claim 2 further comprising:
an inquirer that, in a case where the information processing device is the third device, makes an inquiry to the second device about reliability of the second device upon receiving a request for the reliability information from the first device.

6. The information processing device according to claim 1, wherein
the acquisitor
acquires the context data from the second device via the third device in a case where the determiner determines that the second device is reliable.

7. The information processing device according to claim 1, wherein
reliability of a device includes reliability of the entire device, reliability of each of one or more sensors included in the device, and reliability of each piece of the context data acquired by the device from the sensors,
the determiner
is able to determine reliability of the second device for the entire device, for each of the sensors, or for each piece of the context data, and
the acquisitor
is able to acquire the context data from the second device for the entire device, for each of the sensors, or for each piece of the context data determined to be reliable by the determiner.

8. An information processing method executed by an information processing device, the information processing method comprising:
a determination process of determining, in a case where the information processing device is a first device that acquires context data held by a second device, reliability of the second device with respect to the first device based on reliability of the second device with reference to a third device that is reliable with respect to the first device; and
an acquisition process of acquiring the context data from the second device in a case where the second device is determined to be reliable in the determination process.

9. A non-transitory computer readable storage medium that stores an information processing program that causes a computer to execute
a determination procedure of determining, in a case where the computer is a first device that acquires context data held by a second device, reliability of the second device with respect to the first device based on reliability of the second device with reference to a third device that is reliable with respect to the first device; and
an acquisition procedure of acquiring the context data from the second device in a case where the second device is determined to be reliable by the determination procedure.
